(19) United States
(12) Patent Application Publication
(10) Pub. No.: US 2005/0154915 A1
(43) Pub. Date: Jul. 14, 2005

(54) Networked computer user identification and authentication apparatus method and system

(76) Inventors: Matthew T. Peterson, Lindon, UT (US); Charles Wynn Wilkes JR., Orem, UT (US)

Correspondence Address: KUNZLER & ASSOCIATES, 8 EAST BROADWAY, SALT LAKE CITY, UT, 84111, US

(21) Appl. No.: 10/754,215

(22) Filed: Jan. 9, 2004

(51) Int. Cl. H04L 9/00

(52) U.S. Cl. 713/201

(57) ABSTRACT

Authentication information, identification information, and domain configuration data are cached on a networked computer to provide increased reliability and performance. An update module manages a local cache containing a copy of centrally managed data from a domain server, directory server, or the like. An update request is sent to the update module in response to an information request by a local process. The update request may be a deferrable or non-deferrable request. Non-deferrable requests are immediately processed while deferrable requests may be deferred to a convenient time. The use of deferrable requests facilitates consolidation of cache updates and significantly reduces the processing and communications burden associated with maintaining the authentication information, identification information, and configuration data on the local networked computer.

### BACKGROUND OF THE INVENTION

1. Field of the Invention

The present invention relates generally to managing users of networked computers. Specifically, the invention relates to apparatus, methods, and systems for identifying and authenticating users of networked computers.

2. Description of the Related Art

Directory services are repositories for information about network-based entities, such as applications, files, printers, and people. Directory services provide a consistent way to name, describe, locate, access, manage, and secure information about these resources. The directories associated with directory services are typically hierarchical structures such as a tree with each node in the hierarchy capable of storing information in a unit often referred to as a container. Enterprises may use directory servers and directory services to centrally manage data that is accessed from geographically dispersed locations.

Legacy systems and applications are often unaware of directory services. Nevertheless, legacy systems remain an important element within a networked enterprise. For example machines executing the UNIX™ operating system or derivatives thereof such as LINUX have enjoyed a resurgence in recent years due to their low initial cost, open source business model, and entrenchment within the internet infrastructure.

Despite the resurgence of UNIX-based machines, development and support of applications and utilities is typically more readily accomplished on proprietary operating systems, such as Windows whose installed base is ubiquitous on the desktop. Furthermore, directory services on such proprietary platforms enjoys greater momentum than alternative solutions on UNIX systems.

FIG. 1a is a schematic block diagram depicting one embodiment of a typical prior art networking environment 100 that demonstrates the issues regarding managing currently deployed enterprises. As depicted, the networking environment 100 includes one or more servers 110, a network 120, and one or more networked computers 130. The components of the networking environment 100 may reside at a single site or may be dispersed over multiple sites.

Some of the servers 110 may be directory servers or domain servers which function as a registry for resources and users of the networking environment 100. The network 120 may include routers, bridges, hubs, gateways, and the like which facilitate communications among the components of the networking environment 100. Consequently, communications between components of the networking environment 100 may be indirect and involve multiple “hops” which may significantly increase communication latency.

In addition to latency constraints, network congestion may occur when components dispersed about the networking environment 100 require communications with commonly accessed components such as the servers 110. Network congestion may hamper or prohibit network communications and consequently block processes executing on the components of the networking environment 100. In particular, operating system calls that identify and authenticate resources and users of the networking environment 100 (such as displaying a directory listing) may access directory servers, domain servers, or the like, and congest and/or degrade the network 120 and the networked computers 110. Users that invoke such operating system calls may be unaware of the communications and processing load placed on the network 120 and associated components, and may persist in such practices oblivious to the consequences to other users.

Some of the networked computers 130 may execute legacy applications and operating systems that are unable to integrate with the servers 110 that are directory servers. Furthermore, the communications conducted by the legacy networked computers 130 related to user authentication, user identification, and domain configuration data may be conducted in an insecure format such as clear text.

FIG. 1b is a schematic block diagram depicting one embodiment of a typical prior art configuration data retrieval system 140. The configuration data retrieval system 140 includes a binding module 150 and a local process 160 residing on a local computer 130 and a server process 170 residing on a server 110 or the like that accesses a configuration data store 180. The configuration data retrieval system 140 may include multiple servers 110 with configuration data stores 180 that are copies of a master configuration data store (not shown). The configuration data retrieval system 140 is useful for distributing configuration data to local processes such as the local process 160.

The binding module 150 indicates the location of the server process 170 in order that remote procedure calls 162 may be generated to access the information in the configuration data store 180. In one embodiment, the binding module 150 is a UNIX™ ypbind daemon that retains information on the whereabouts of server processes that provide Network Informations Services (NIS) such as a listing of computers within a domain. The server process receives the remote procedure calls 162 and provides configuration information 172 or the like to the local process 160. The communications involved in requesting and providing the configuration data may be insecure.

Although useful for a homogenous environment such as a network of only UNIX™ machines, the configuration data retrieval system 140 does not address the needs of heterogeneous networking environments containing computers and equipment executing a variety of operating systems. In particular, network administration tools (not shown) used by network administrators may be hosted on machines executing an operating system different from the local computer 130 such as Windows™. The local processes 160 may be unaware of the API calls or similar mechanisms required to tap into the network configuration data created by such network administration tools. Reprogramming such applications to access network configuration data hosted by another operating system, if possible, is typically quite expensive.

Given the challenge of administering heterogeneous networking environments within enterprises, what is needed are apparatus, methods, and systems that provide centralized management of network configuration, identification, and authentication data in a manner that is transparent to local processes. Such means and methods would facilitate centralized administration while minimizing the impact on legacy applications and operating systems.

### SUMMARY OF THE INVENTION

The present invention has been developed in response to the present state of the art, and in particular, in response to the problems and needs in the art that have not yet been fully solved by currently available directory systems. Accordingly, the present invention has been developed to provide an apparatus, method, and system for authenticating and identifying users of a computer network on a local computer that overcome many or all of the above-discussed shortcomings in the art.

In one aspect of the present invention, an apparatus for authenticating users of a computer network on a local computer includes an authentication module residing on a local computer that receives authentication information from a domain server via a network, and a permission database configured to cache the authentication information on the local computer.

In another aspect of the present invention, an apparatus for identifying users of a computer network on a local computer includes an identification module residing on a local computer that receives identification information from a domain server via a network, and a permission database configured to cache the identification information on the local computer.

The apparatus for authenticating users and the apparatus for identifying users may be integrated together into a single apparatus that performs the function of each unit. In certain embodiments, the domain server is a KERBEROS compliant key distribution center or an X.500 directory system agent, and communications are conducted using KERBEROS or lightweight directory access protocol (LDAP). The authentication module and the identification module may be a dynamically linked module such as a pluggable authentication module (PAM), a loadable authentication module (LAM), or a name service switch (NSS) module.

The described apparatus may also include an update module that manages a local information cache, which in one embodiment is a permission database containing access-allowed information and access-denied information for users and groups. In one embodiment, the update information is tracked using a universal serial number associated with the domain server. In certain embodiments, the update module may pre-load the information cache or permission database in response to joining a domain or similar operation. The update module may respond to deferrable and non-deferrable update requests and retrieve incremental update information from the domain server or the like. In one embodiment, the update module is a POSIX compliant daemon.

In one embodiment, the authentication module generates a non-deferrable update request to the update module in response to an authentication request from a local process, and the identification module generates a deferrable update request to the update module in response to an identification request from a local process. Deferrable requests to the update module may be consolidated and deferred to a later or more convenient time, such as reception of a non-deferrable update request. The combination of deferrable and non-deferrable requests facilitates providing cache coherency when needed, while reducing the communications and processing burdens on the domain server and associated network components.

The authentication module may be a dynamically linked module. In one embodiment, the authentication module is a UNIX™ PAM module that responds to user authentication requests, login requests, session requests, account restrictions requests, password change requests, and the like.

In another aspect of the present invention, a method for authenticating users of a computer network on a local computer includes receiving authentication information from a domain server via a network, locally caching the authentication information, and retrieving incremental update information from the domain server. Retrieving incremental update information from the domain server may be conducted in response to an authentication request from a local process.

In another aspect of the present invention a method for identifying users of a computer network on a local computer includes receiving identification information from a domain server via a network, locally caching the identification information, and retrieving incremental update information from the domain server.

The method for authenticating users of a computer network and the method for identifying users of a computer network may be integrated into a single method that authenticates and identifies users using shared resources. The methods may also include caching the authentication and/or identification information by maintaining a permission database, and pre-loading the permission database in response to joining a domain.

Incremental updates to the authentication and/or identification information may be managed by tracking a universal serial number associated with the domain server. In one embodiment, an incremental update is conducted in response to an identification request from a local process after a deferral interval, while authentication requests result in conducting an immediate incremental update.

In another aspect of the present invention, an apparatus for centrally managing configuration data for a domain includes a local process that generates remote procedure calls related to retrieving configuration data for a domain and a binding module configured to direct remote procedure calls to a local server process. The local server process may be a directory services module configured to retrieve configuration data from a directory server or the like.

In another aspect of the present invention, a method for centrally managing configuration data includes generating remote procedure calls related to retrieving configuration data for a domain with a local process, directing the remote procedure calls to a local server process, retrieving the configuration data from a directory server, and locally caching the configuration data. The method may also include updating the configuration data for the domain from a directory server.

The apparatus and method for centrally managing configuration data facilitate administering and distributing configuration data from a directory server in a secure manner that is transparent to legacy systems and applications that are typically unaware of directory services. The configuration data may be incrementally updated within a local cache using the same mechanisms for update as for authentication and identification data previously discussed. The local server process may access the local cache to provide the requested configuration data to the requesting local process.

The various elements and aspects of the present invention improve user authentication, user identification, domain configurability, and network administration within an enterprise or the like. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1a is a schematic block diagram depicting one embodiment of a typical prior art networking environment wherein the present invention may be deployed;

FIG. 1b is a schematic block diagram depicting one embodiment of a typical prior art configuration data retrieval system;

FIG. 2 is a flowchart diagram depicting one embodiment of a user information caching method of the present invention;

FIG. 3 is a schematic block diagram depicting one embodiment of a user identification and authentication apparatus of the present invention;

FIG. 4 is a flowchart diagram depicting one embodiment of a cache update method of the present invention;

FIG. 5 is a flowchart diagram depicting one embodiment of an update request method of the present invention;

FIG. 6 is a flowchart diagram depicting one embodiment of a update completed method of the present invention;

FIG. 7 is a flowchart diagram depicting one embodiment of an update timeout method of the present invention;

FIG. 8 is a schematic block diagram depicting one embodiment of a configuration data retrieval system of the present invention; and

FIG. 9 is a flowchart diagram depicting one embodiment of a configuration data retrieval method of the present invention.

### DETAILED DESCRIPTION OF THE INVENTION

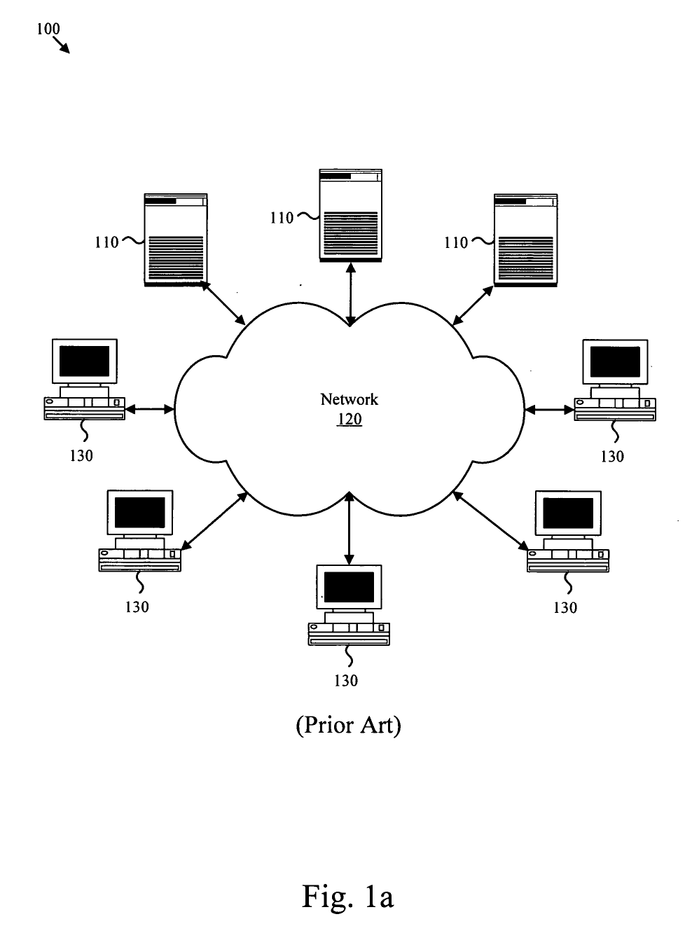

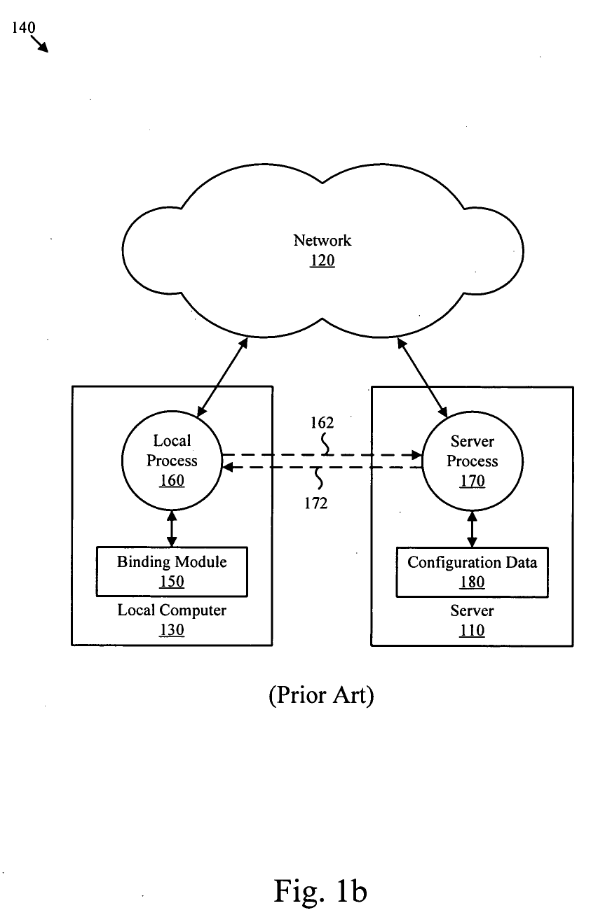

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 9, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics maybe combined in any suitable manner in one or more embodiments.

As depicted in FIGS. 1a and 1b and described in the background section, there is a need to integrate computers executing legacy applications and operating systems with directory services and similar centrally administered network services.

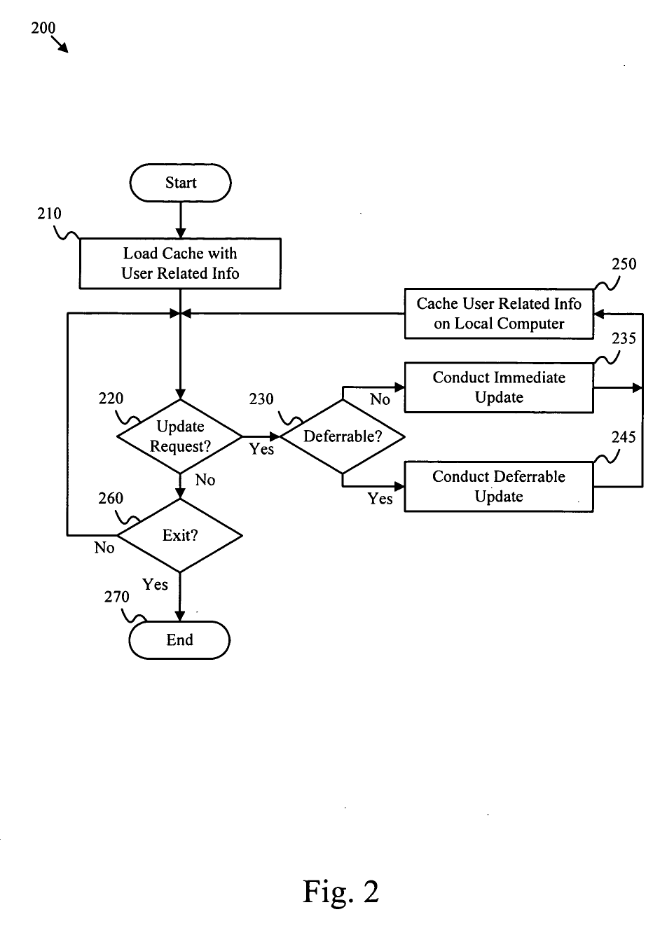

FIG. 2 is a flowchart diagram depicting one embodiment of a user information caching method 200 of the present invention. The depicted user information caching method 200 includes a load cache step 210, an update request test 220, a deferrable test 230, a conduct immediate update step 235, a conduct deferrable update step 245, a cache user information step 250, and an exit test 260. The user information caching method 200 may be conducted on a networked computer such as the local computer 130 depicted in FIG. 1a and elsewhere.

The load cache step 210 retrieves user information from a directory server, domain server or the like, that tracks information related to users of a network and stores that information in a locally accessible data store such as a cache. The communications used to retrieve the user-related information may be secure to protect the information. The user-related information may include user-specific info as well as information common to entities to which the user belongs such as group information, organization unit information, container information, and domain information. In one embodiment, the load cache step 210 is conducted in response to joining a domain.

The update request test 220 ascertains whether a request to update the user information has occurred. If a request has occurred, the deferrable test 230 ascertains whether the request is a deferrable request. If the request is not deferrable, the method 200 executes the conduct immediate update step 235, otherwise the method proceeds to the conduct deferrable update step 245.

The conduct immediate update step 235 immediately updates the user-related information that is cached on the local computer. Conducting an immediate update facilitates providing information to a local process that may be time-critical. The conduct deferrable update step 245 also conducts a requested update of the user-related information on the local computer. However, execution of the actual update may be deferred to a convenient time and may or may not occur before information is extracted from the cache by a local process or the like.

In certain embodiments, a maximum deferral interval indicates how long a deferrable update may be deferred. In one embodiment, the maximum deferral interval is a system parameter. In another embodiment, the maximum deferral interval is specified by the local process. Conducting a deferrable update facilitates fulfilling multiple update requests with a single update and reduces the processing and communications imposed on network components such as the network components depicted in FIG. 1a.

In one embodiment of the present invention, authentication requests are considered non-deferrable requests and identification requests are considered deferrable requests. In another embodiment, a local process may explicitly specify whether an update request is deferrable or non-deferrable. In certain embodiments, both deferrable and non-deferrable update requests are fulfilled by conducting incremental updates using a secure communications format that protects the transported data.

The cache user info step 250 places the update information retrieved in step 235 or 245 in the locally accessible data store. The method subsequently loops to the update request test 220. In the event that no update requests are pending, the depicted user information caching method 200 proceeds to the exit test 260. The exit test 260 ascertains whether a request to exit the method 200 has been generated. If a request to exit the method 200 has been generated, the method 200 ends 270. If a request to exit the method 200 has not been generated, the method loops to the update request test 220.

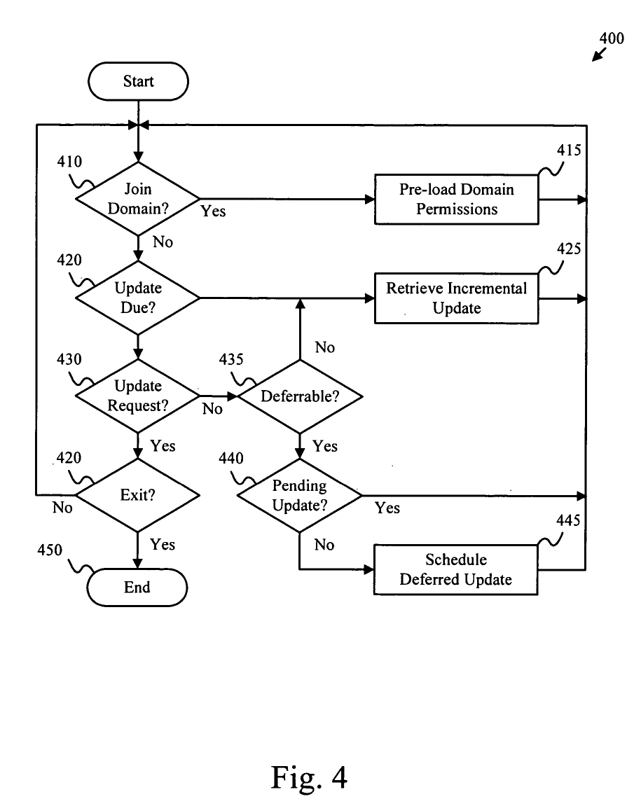

For purposes of illustration, the user information caching method 200 is shown in simplified form. Further details of one particular embodiment are shown in FIGS. 4 through 7. Although depicted as a polling loop, the method may be implemented in an event-driven form or with a similar construct familiar to those of skill in the art. The user information caching method 200 reduces network congestion related to retrieving user-related information from a centralized directory server or the like. The use of deferrable update requests facilitates fulfilling multiple requests with a single update.

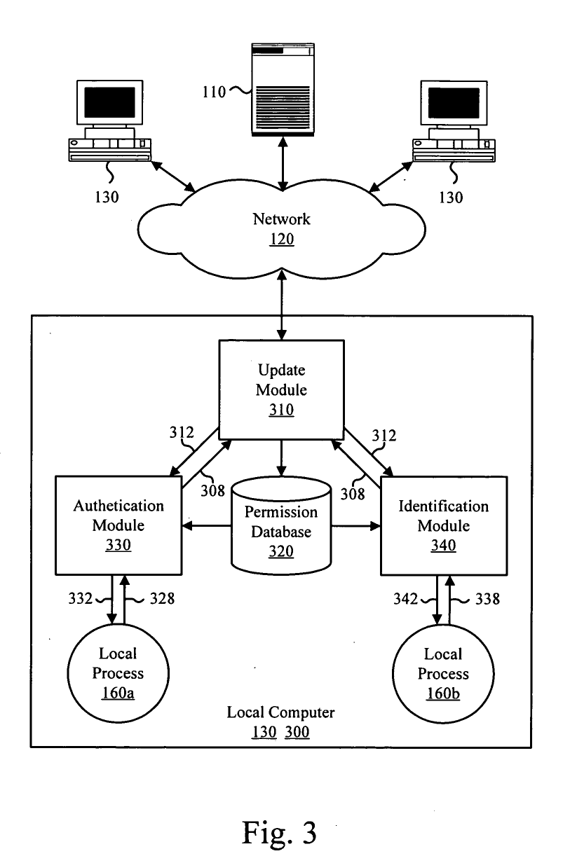

FIG. 3 is a schematic block diagram depicting one embodiment of a user identification and authentication apparatus 300 of the present invention along with elements of the prior art networking environment 100. The user identification and authentication apparatus 300 includes an update module 310, a permission database 320, an authentication module 330, and an identification module 340. The user identification and authentication apparatus 300 facilitates identifying and authenticating users in a secure, efficient, and reliable manner.

The update module 310 maintains and updates the permission database 320. The update module 310 receives update requests 308 and provides update responses 312. In the depicted arrangement, the update module 310 is exclusively responsible for loading, inserting, deleting, or modifying information within the permission database 310 via the update stream 318. The permission database 320 may include information on allowed and/or disallowed users, groups, containers such as organizational units, and the like. In one embodiment, incremental updates are conducted as needed, and the permission database is pre-loaded in response to the local computer 130 joining a domain.

The permission database 320 functions as a cache for authentication and identification information and the update module 310 provides caching control directed by requests from local processes. Storing allowed and disallowed information within the permission database 320 facilitates conducting authentication and identification operations without requiring immediate access to a domain server, directory server, or the like.

In the depicted embodiment, the authentication module 330 receives authentication requests 328 from a local process 160a and provides authentication responses 332. The authentication module may be a dynamically linked module. In one embodiment, the authentication module is a POSIX compliant PAM module that responds to requests such as authentication requests, login requests, session requests, account restrictions requests, and password change requests.

In similar fashion to the authentication module 330, the identification module 340 receives identification requests 338 from a local process 160b and provides identification responses 342. The local process 160a and 160b may be the same process or different processes.

The authentication module 330 and the identification module 340 may request an update of the permission database from the update module 310. Deferrable and non-deferrable updates may be requested. Deferrable update requests may be deferred until a convenient time in order to increase network and system efficiency. For example, a large number of deferred update requests may be fulfilled along with a non-deferrable update request. In one embodiment, unfulfilled deferrable update requests are changed to non-deferrable update requests after expiration of a maximum deferral interval.

The ability to use deferrable and non-deferrable update requests facilitates balancing the cache coherency of the local information, and the communications and processing burden associated with maintaining coherency. For example, requests for information that are considered non-critical may be deferred, while cache coherency may be maximized for critical requests by conducting an immediate non-deferrable update. In certain embodiments, deferrable update requests are associated with the identification requests 338, and non-deferrable update requests are associated with the authentication requests 328.

The depicted arrangement of the modules within the user identification and authentication apparatus 300 facilitates reliable and efficient processing of identification and authentication requests. In certain embodiments, the authentication module 330 or the identification module 340 may schedule a timeout event that is executed if the update module 310 fails to respond to an update request (with the update response 312) within the allotted time interval. The use of timeout events increases system reliability and prevents authentification or identification processing from halting or hanging due to a disconnected network connection, an unresponsive server, network congestion, or the like.

The user identification and authentication apparatus 300 facilitates management of identification, and authentication data from a centralized domain server in a manner that is transparent to local processes. For example, the centralized domain server may be a KERBEROS compliant key distribution center or an X.500 directory system agent that communicates with legacy applications and systems using a protocol such as KERBEROS or lightweight directory access protocol (LDAP). The relationship of the modules of the user identification and authentication apparatus 300 provides backward compatibility with legacy applications and improves the performance and reliability of identification and authentication processing.

FIG. 4 is a flowchart diagram depicting one embodiment of a cache update method 400 of the present invention. The depicted cache update method 400 includes a join domain test 410, a pre-load permissions step 415, an update due test 420, a retrieve incremental update step 425, an update request test 430, a deferrable test 435, an update pending test 440, a schedule deferred update step 445, and an exit test 420. The cache update method 400 may be conducted by the update module 310, or may be conducted independently thereof.

The join domain test 410 ascertains whether the local computer has recently joined a domain or if request to join a domain has occurred. If the test is affirmative, the cache update method 400 conducts the pre-load permissions step 415. If the test is not affirmative, the method proceeds to the update due test 420.

The pre-load permissions step 415 pre-loads a local cache such as the permission database 320 with pertinent information from a domain server, directory server or the like. Essentially, the pre-load permissions step 415 establishes a baseline from which incremental updates may be conducted.

The update due test 420 ascertains whether a scheduled or deferred update is due to be executed. If such an update is due, the cache update method 400 conducts the retrieve incremental update step 425. If such an update is not due, the cache update method 400 proceeds to the update request test 430.

The retrieve incremental update step 425 retrieves an incremental update from a domain server, directory server, or the like. Since an incremental update is completed by retrieve incremental update step 425, any pending update events scheduled by the schedule deferred update step 445 described below are considered fulfilled and may be canceled. In one embodiment, changes to the user-related information are tracked via a universal serial number and all changes since a latest received change are retrieved. Conducting incremental updates reduces the communications and processing burden on the various components involved in storing, transmitting, and caching the requested information.

The update request test 430 ascertains whether a request to update the local cache has occurred. If a request has occurred, the deferrable test 435 ascertains whether the request is a deferrable request. If the request is not deferrable, the method 400 conducts the retrieve incremental update test 425 as previously described. If the request is deferrable, the update pending test 440 ascertains whether a deferred update is pending. If a deferred update is pending, the method 400 loops to the join domain test 410. If a deferred update is not pending, the method 400 conducts the schedule deferred update step 445.

The scheduled deferred update step 445 schedules a deferred update. In one embodiment, an update event is scheduled to execute at the current system time plus a maximum deferral interval.

The exit test 420 ascertains whether a request to exit the method 400 has occurred. If such a request has occurred, the method ends 450, otherwise, the method loops to the join domain test 410.

The cache update method 400 reduces the number of cache updates while maintaining cache coherency with a domain server, directory server, or the like, in a selectable basis.

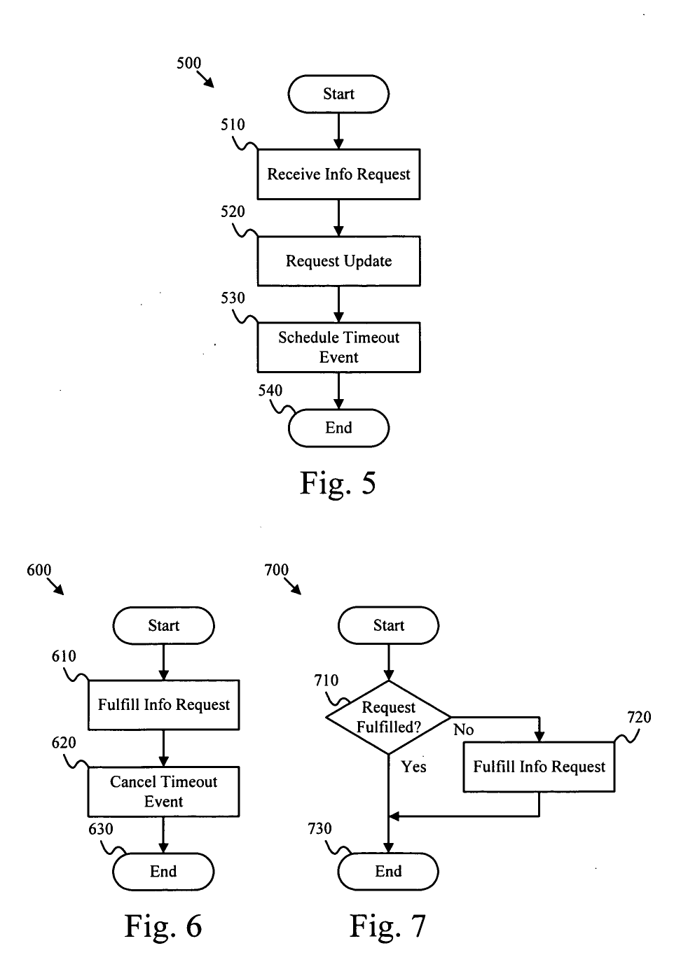

FIGS. 5-7 are flowcharts that depict methods that may be conducted in a coordinated fashion to substantially eliminate blocking common in prior art environments. The depicted methods may be conducted by the authentication module 330 and the identification module 340 on a legacy networked computer to increase the performance and reliability of authenticating and identifying users. The depicted methods may also be conducted independently thereof.

FIG. 5 is a flowchart diagram depicting one embodiment of an update request method 500 of the present invention. The depicted update request method 500 includes a receive information request step 510, a request update step 520, and a schedule timeout event step 530. The update request method 500 may be conducted by the authentication module 330, the identification module 340, or the like to generate the update request 308 depicted in FIG. 3.

The receive information request step 510 receives an information request from a local process such as the authentication request 328 or the identification request 338 depicted in FIG. 3. The request update step 520 requests an update of the information within the relevant cache such as the permission database 320. In one embodiment, the request update step 520 corresponds to generating the update request 308.

The schedule timeout event step 530 schedules a timeout event in case the update request 308 is not responded to (with the update response 312). The update request method 500 then ends 540 without waiting for a response to the generated update request 308. By not waiting for a response, process blocking is avoided.

FIG. 6 is a flowchart diagram depicting one embodiment of a update completed method 600 of the present invention. The depicted update completed method 600 includes the fulfill information request step 610 and the cancel timeout event step 620. The depicted update completed method 600 may be conducted by the authentication module 330, the identification module 340, or the like, in response to receiving a response to an update request such as the update response 312 depicted in FIG. 3.

The fulfill information request step 610 fulfills the original information request received in step 510 or the like. In one embodiment, fulfilling the information request comprises populating a data structure and returning from an invoked function call. The cancel timeout event step 620, cancels a timeout event associated with an update request such as the timeout event scheduled by the schedule timeout event step 530. Subsequent to the cancel timeout event step 620, the update completed method 600 ends 630.

FIG. 7 is a flowchart diagram depicting one embodiment of an update timeout method 700 of the present invention. The depicted update timeout method 700 includes an update fulfilled test 710 and a fulfill information request step 720. The depicted update timeout method 700 may be conducted by the authentication module 330, the identification module 340, or the like, in response to a timeout event such as a timeout event scheduled by the schedule timeout event step 530 depicted in FIG. 5.

The update fulfilled test 710 ascertains whether an update request such as the update request 308 has been fulfilled. If the update request has been fulfilled, the update timeout method 700 ends 730. If the update request has not been fulfilled, the method conducts the fulfill information request step 720. The fulfill information request step 720 fulfills the original information request received in step 510, or the like. In the depicted embodiment, the fulfill information step 720 is essentially identical to the fulfill information step 610.

In the depicted embodiments, the update completed method 600 and the update timeout method 700 work together to ensure that information requests are fulfilled once and only once despite unpredictable responses to update requests generated by the an update request method 500 or the like. Locking mechanisms familiar to those of skill in the art such as test and set instructions may be required to ensure proper performance on a particular platform or operating system.

As depicted in FIG. 1b and described in the background section, there is a need to integrate applications generating Network Informations Services (NIS) remote procedure calls on legacy systems such as UNIX™ machines with directory services and other centrally administered network services that may be executing on other platforms.

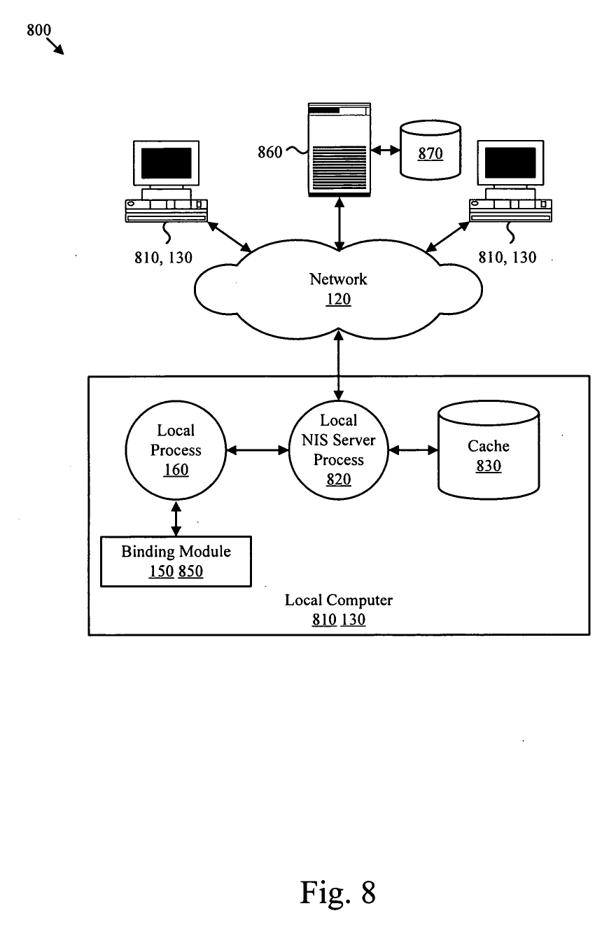

FIG. 8 is a schematic block diagram depicting one embodiment of a configuration data retrieval system 800 of the present invention. The depicted configuration data retrieval system 800 includes many components from the prior art configuration data retrieval system 140 including a binding module 150 and a local process 160 residing on a local computer 130. However, the local computer 130 is a specially configured computer 810 with a local server process 820, and a cache 830 that leverages the services of a directory server 860 to provide distributed access to centrally managed configuration data such as NIS maps.

The depicted binding module 150 is a specially configured binding module 850 that is configured to reference the local server process 820. The local server process 820 is configured to interface with the directory server 860 and update the cache 830 with changes made to a directory services data store 870. By referencing the local server process 820, local processes 160 may retrieve configuration data from the directory server 860 in a transparent manner.

The local server process 820 may update the cache 830 with configuration data from the directory server in much the same fashion as the update module 310 updates the permission database 320 with authentication and identification data from a domain server or directory server 110 as described in conjunction with FIG. 3 and elsewhere. In one embodiment, the local server process 820 also functions as the update module 310 and the server 110 and the directory server 860 may be the same server.

The directory server 860 and the directory services data store 870 provide a central location for managing and distributing directory services. The present invention extends the reach of the directory server 860 and the directory services data store 870 to providing domain configuration data such as NIS maps to legacy networked computers.

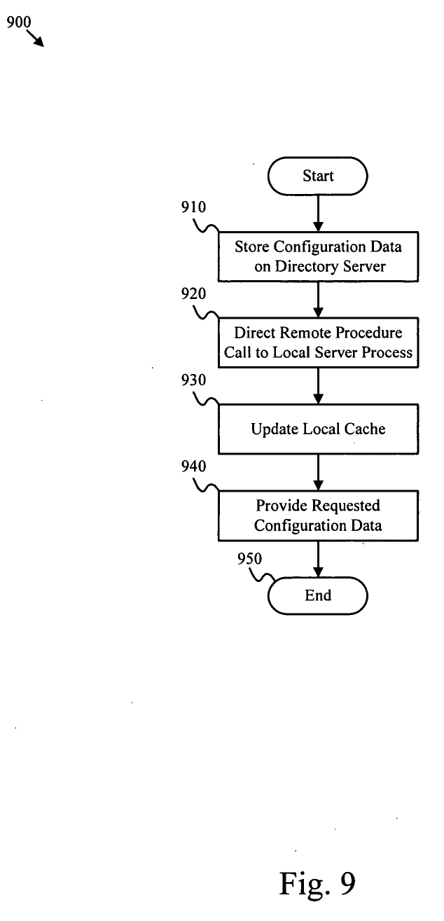

FIG. 9 is a flowchart diagram depicting one embodiment of a configuration data retrieval method 900 of the present invention. The depicted configuration data retrieval method 900 includes a store configuration data step 910, a direct remote procedure call step 920, an update cache step 930, and a provide configuration data step 940.

The store configuration data step 910 stores configuration data on a directory server such as the directory server 860 depicted in FIG. 8. In one embodiment, the directory server 860 is a Microsoft Active Directory™ Server. The direct remote procedure call step 920 directs legacy remote procedure calls for accessing configuration data (such as NIS map calls to a local server process) to the local server process 820 or the like. The calls are received by the local server process and analyzed to determine if any configuration data is requested by the calling process.

The update cache step 930 ascertains whether the local cache needs to be updated with configuration data and updates the local cache from the directory server 860 if an update is needed. The provide configuration data step 940 provides the requested configuration data to the calling process. Subsequent to the provide configuration data step 940, the configuration data retrieval method 900 ends 950.

The present invention improves management and distribution of user information and configuration data within an enterprise. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for authenticating and identifying users of a computer network on a local computer, the apparatus comprising:
a permission database configured to cache authentication and identification information on a local computer; and
an update module configured to retrieve an incremental update of the authentication and identification information from a domain server.

2. The apparatus of claim 1, further comprising an authentication module residing on the local computer, the authentication module configured to receive a request from a local process and generate a non-deferrable update request to the update module.

3. The apparatus of claim 2, wherein the authentication module is a dynamically linked module selected from the group consisting of a pluggable authentication module, and a loadable authentication module.

4. The apparatus of claim 2, wherein the request from a local process is selected from the group consisting of an authentication request, a login request, a session request, an account restrictions request, and a password change request.

5. The apparatus of claim 1, further comprising an identification module residing on the local computer, the identification module configured to receive an identification request from a local process and generate a deferrable update request to the update module.

6. The apparatus of claim 5, wherein the identification module is a dynamically linked module.

7. The apparatus of claim 1, wherein the update module is a POSIX compliant daemon.

8. The apparatus of claim 1, wherein the domain server is a key distribution center.

9. The apparatus of claim 1, wherein the domain server is a directory system agent.

10. The apparatus of claim 1, wherein the update module is further configured to pre-load the permission database in response to joining a domain.

11. The apparatus of claim 1, wherein the incremental update is tracked using a universal serial number associated with the domain server.

12. The apparatus of claim 1, wherein the authentication and identification information is selected from the group consisting of user information, group information, organization unit information, container information, and domain information.

13. The apparatus of claim 1, wherein the authentication and identification information comprises access-allowed information and access-denied information.

14. The apparatus of claim 1, wherein the authentication information is received using KERBEROS.

15. An apparatus for authenticating users of a computer network on a local computer, the apparatus comprising:
an authentication module residing on a local computer, the authentication module configured to receive authentication information from a domain server via a network; and
a permission database configured to cache the authentication information on the local computer.

16. An apparatus for identifying users of a computer network on a local computer, the apparatus comprising:
an identification module residing on a local computer, the identification module configured to receive identification information from a domain server via a network; and
a permission database configured to cache the identification information on the local computer.

17. A method for authenticating and identifying users of a computer network on a local computer, the method comprising:
retrieving authentication and identification information from a domain server via a network;
caching the authentication and identification information on a local computer; and
retrieving an incremental update of the authentication and identification information from the domain server.

18. The method of claim 17, further comprising conducting a deferrable update of the authentication and identification information in response to receiving an identification request from a local process.

19. The method of claim 17, further comprising conducting an immediate update of the authentication and identification information in response to receiving an authentication request from a local process.

20. The method of claim 17, wherein caching the authentication and identification information comprises maintaining a permission database.

21. The method of claim 17, further comprising pre-loading the permission database in response to joining a domain.

22. The method of claim 17, further comprising tracking a universal serial number. associated with the domain server.

23. The method of claim 17, wherein the authentication and identification information is selected from the group consisting of user information, group information, organization unit information, container information, and domain information.

24. The method of claim 17, wherein the authentication and identification information comprises access-allowed information and access-denied information.

25. The method of claim 17, further comprising receiving a request from a local process selected from the group consisting of a login request, a session request, an account restrictions request, and a password change request.

26. The method of claim 17, further comprising communicating with the domain server using lightweight directory access protocol (LDAP).

27. An apparatus for authenticating and identifying users of a computer network on a local computer, the apparatus comprising:
means for retrieving authentication and identification information from a domain server via a network;
means for caching the authentication and identification information on a local computer;
means for conducting a deferrable update of the authentication and identification information in response to receiving an identification request from a local process; and
means for conducting an immediate update of the authentication and identification information in response to receiving an authentication request from a local process.

28. A computer readable storage medium comprising computer readable program code for authenticating and identifying users of a computer network on a local computer, the program code configured to conduct a method comprising:
retrieving authentication and identification information from a domain server via a network;
caching the authentication and identification information on a local computer;
conducting a deferrable update of the authentication and identification information in response to receiving an identification request from a local process; and
conducting an immediate update of the authentication and identification information in response to receiving an authentication request from a local process.

29. A system for authenticating and identifying users of a computer network on a local computer, the system comprising:
a domain server; and
a local computer configured to receive cache authentication and identification information from the domain server, the local computer comprising:
a permission database configured to cache authentication and identification information from the domain server, the permission database comprising users-allowed information and users-denied information, and
an update module configured to retrieve incremental update information from a domain server and update the permission database.

30. The system of claim 29, wherein the local computer further comprises an authentication module configured to receive an authentication request from a local process and generate a non-deferrable update request to the update module.

31. The system of claim 29, wherein the local computer further comprises an identification module configured to receive an identification request from a local process and generate a deferrable update request to the update module.

32. A method for centrally managing configuration data for a domain, the method comprising:
generating remote procedure calls related to retrieving configuration data for a domain with a local process;
directing the remote procedure calls to a local server process;
retrieving the configuration data from a directory server; and
locally caching the configuration data.

33. The method of claim 32, further comprising updating the configuration data for the domain from a directory server using a local server process.
